(19) United States
(12) Patent Application Publication
(10) Pub. No.: US 2018/0347739 A1
(43) Pub. Date: Dec. 6, 2018

(54) TUBULAR QUICK COUPLING COMPRISING DIVISIBLE RING FOR SECURE FLUID CONNECTION

(71) Applicant: A. RAYMOND ET CIE, Grenoble (FR)

(72) Inventors: Clément CHATELAIN, Grenoble (FR); Quentin RABUT, Saint Nicolas de Macherin (FR)

(21) Appl. No.: 15/779,047

(22) PCT Filed: Nov. 7, 2016
(86) PCT No.: PCT/FR2016/052874

§ 371 Date: May 24, 2018

(30) Foreign Application Priority Data
Nov. 30, 2015 (FR) 1561538

(51) Int. Cl. F16L 37/091; F16L 37/098

(52) U.S. Cl. CPC F16L 37/0915; F16L 2201/20; F16L 37/0985; F16L 37/0982

(57) ABSTRACT

A tubular quick coupling comprises a first tubular element with a hollow connector body defining an axial orifice that is to receive a second tubular element provided with a circular rib, a latch blocked axially in the first tubular element and radially actuatable to release the second tubular element from the first tubular element, and a security system that prevents the second tubular element being withdrawn. The security system is a flexible and breakable ring that has a perimeter portion inside the first tubular element between the inlet of the orifice of the body and the latch in order to block the second tubular element coaxially in the first tubular element in spite of actuating the latch, and the ring has at least one perimeter portion in the form of a breakable loop that projects outside the body.

This application is a 371 national phase entry of PCT/FR2016/052874, filed 7 Nov. 2016, which claims benefit of French Patent Application No. 1561538, filed 30 Nov. 2015, the entire contents of which are incorporated herein by reference for all purposes.

### TECHNICAL FIELD

The invention relates to a tubular quick coupling comprising a first tubular element with a hollow body defining an axial orifice that is to receive a second tubular element provided with a circular rib, a latch blocked axially in said first tubular element and radially actuatable to release the second tubular element from the first tubular element, and a security system that opposes release of the second tubular element being withdrawn.

### RELATED ART

In the automobile industry, tubular quick couplings are used for coupling together two fluid transport pipes, and in particular for coupling the fuel injector, the filter, the radiator, or any other appropriate equipment and/or in any other similar technical field.

Tubular couplings generally comprise a first tubular element with a hollow body provided with a housing that is to receive by snap-fastening a second tubular element with a latch arranged in the housing to block the second element axially in the first element, the latch being actuatable to release the second element if it is desired to uncouple the coupling in intentional manner.

Such tubular couplings are known in particular from the publications U.S. Pat. No. 6,086,119 and WO 2014/170590.

Certain manufacturers are now seeking to make secure the connection between the two tubular elements after the connection has been set up so as to be able to prevent non-desired disconnection. For that purpose, it is advantageous to add a security system to prevent the latch being actuated and thus guarantee the connection. By way of example, Documents U.S. Pat. No. 4,573,716, U.S. Pat. No. 4,923,220, and GB 2 490 970 disclose a security system for a tubular coupling corresponding to a lid or a sleeve that takes up a position on the tubular coupling so as to prevent accidental release of the second tubular element of the coupling.

Nevertheless, since those security systems are removable, they do not make it possible to ensure that a connection cannot be disconnected when the pipes are indeed coupled together once the connection has been established.

### SUMMARY

The object of the invention is to remedy those drawbacks by proposing a coupling that is quick and easy to use for providing a secure fluid flow connection while still remaining capable of being uncoupled when that is necessary.

More particularly, the invention provides a tubular quick coupling comprising a first tubular element with a hollow connector body defining an axial orifice that is to receive a second tubular element provided with a circular rib, a latch blocked axially in the first tubular element and radially actuatable to release the second tubular element from the first tubular element, and a security system that opposes release of the second tubular element being withdrawn, the coupling being characterized in that the security system is a flexible and breakable ring that has a perimeter portion inside the first tubular element between the inlet of the orifice of the body and the latch in order to block the second element coaxially in the first element in spite of actuating the latch, the ring having at least one perimeter portion in the form of a breakable loop that projects outside the body.

The tubular quick coupling of the invention may also present the following particular features:
the ring may include on the perimeter portion inside the first tubular element at least one rib that slopes radially so that during axial engagement of the second tubular element in the axial orifice, the rib moves radially outwards under the effect of the axial pressure of the circular rib on the sloping portion of the rib so as to allow the circular rib to pass through and then be held tight behind the circular rib;
the sloping rib may further include a barb catch that comes into contact with the circular rib of the second tubular element and an inside groove of the hollow body to block the second tubular element axially in the first tubular element;
the ring may have two sloping ribs that are diametrically opposite;
the ring may include at least one retaining catch that co-operates with an internal groove of the hollow body to block the ring axially in the body of the first tubular element; and
the ring may have two opposite loops.

With this arrangement of the invention, a quick and secure coupling is obtained between two fluid transport pipes by snap-fastening a second element in a first tubular element.

Adding a ring in accordance with the invention as a security system makes it possible to avoid the coupling being uncoupled in uncontrolled manner, thereby guaranteeing that once connection has been established between the pipes, it is maintained by the presence of the barb catches on the ring opposing extraction of the second tubular element. Even when the latch is actuated, the second element remains blocked in the first element.

The ring presents a breakable shape that projects from and is accessible outside the body of the first tubular element. Once this shape is broken, the ring is extracted from the first tubular element in order to uncouple the coupling. Specifically, the ring no longer retains the second element in the body of the first element so the quick coupling can be uncoupled by acting on the latch.

With the coupling of the invention, automobile manufacturers have available a coupling that is quick and easy to use, and that is secure when mounting, while still being capable of being uncoupled, should that be necessary.

### BRIEF DESCRIPTION OF THE DRAWINGS

The present invention can be better understood and other advantages appear on reading the following description and the accompanying drawings, in which:

FIG. 1 is a perspective view of the preassembled tubular quick coupling of the invention;

FIG. 2 is a perspective view of the tubular quick coupling of the invention with the second tubular element connected to and retained in the first tubular element;

FIG. 3 is an exploded perspective view of the tubular quick coupling of the invention with the security ring not assembled in the coupling;

FIG. 4A is a perspective view of the ring of the tubular coupling of the invention;

FIG. 4B is a perspective view that is opposite to FIG. 4A and showing the ring of the tubular coupling of the invention;

FIGS. 5A to 5C are longitudinal section views of the tubular coupling of the invention while mounting the security ring; and

FIGS. 6A and 6B are longitudinal section views showing the mounting of a second tubular element in a tubular coupling of the invention.

### DESCRIPTION OF AN EMBODIMENT

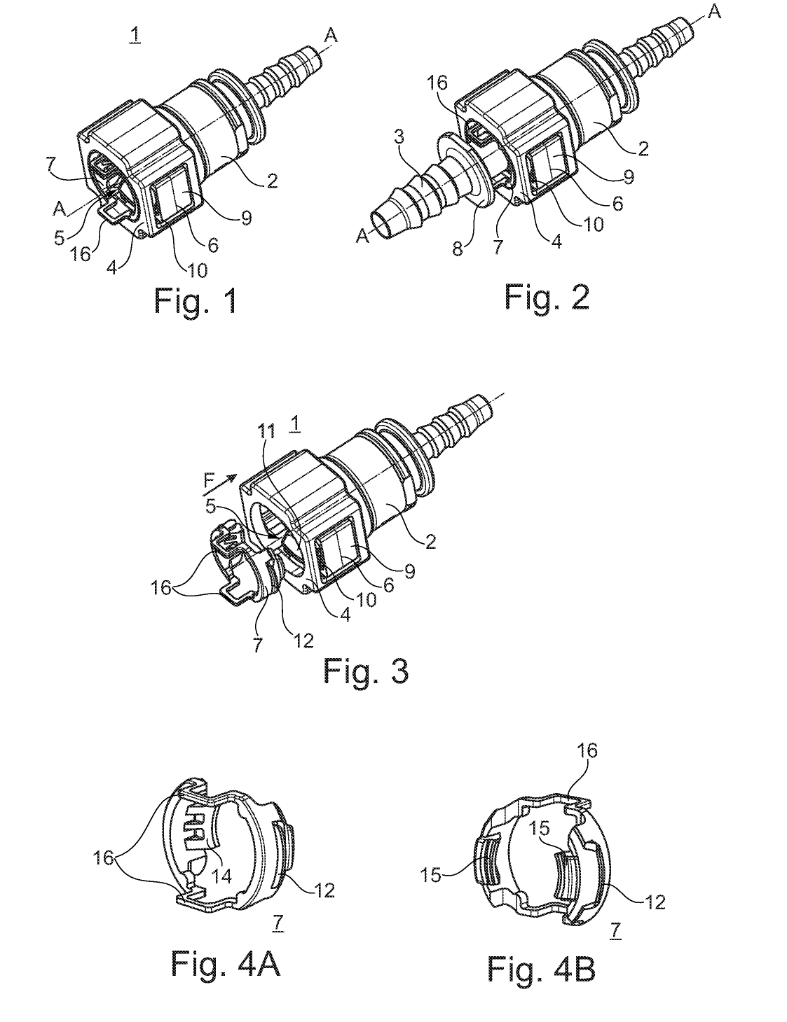

FIG. 1 shows a tubular quick coupling 1 of an embodiment of the invention in the assembled position for connecting tubular fluid flow pipe elements as shown in FIG. 2, in which a first tubular element 2 is connected to a second tubular element 3 along the axis AA.

The first tubular element 2 includes an axial male endpiece secured to a hollow body 4 provided with an axial orifice 5 in axial alignment with the male endpiece of the first tubular element 2. The hollow body 4 defines a housing that is to receive a latch 6 in known manner. In the example embodiment of the invention, a security system, in this example in the form of a ring 7 having two faces that are visible in FIGS. 4A and 4B, is added to the hollow body 4 of the tubular coupling 1 in such a manner as to block the second tubular element 3 in the first tubular element 2 in spite of the latch 6 being actuated.

The second tubular element 3 presents an axial endpiece provided with a circular rib 8. The diameter of the endpiece of the second tubular element 3 is smaller than the diameters of the axial orifice 5 and of the male endpiece of the first tubular element 2 in which it can be received. The second tubular element 3 is axially engaged through the orifice 5 in the first tubular element 2.

The housing in the hollow body 4 of the first tubular element 2 is provided with lateral openings 10 enabling the latch 6 (not shown) to be inserted laterally, while the ring 7 is inserted in the first tubular element 2 by moving in axial translation through the orifice 5 as illustrated by arrow F in FIG. 3.

In known manner, the latch 6 is lozenge-shaped around the axial orifice 5, the lozenge shape having press bars 9 received in the lateral openings 10 of the body 4 of the first tubular element 2, and the sides of this lozenge shape are flexible and provided in their middles with respective sloping sections forming connection catches 11 projecting towards the inside of the axial orifice 5 and towards the outside so as to block the latch 6 in the hollow body 4.

The connection catches 11 are arranged so that during axial engagement of the second tubular element 3 in the axial orifice 5, the circular rib 8 pressing axially against the connection catches 11 causes the connection catches 11 to move apart radially, thereby allowing the circular rib 8 to pass between the connection catches 11 and enabling the second tubular element 3 to be inserted in the first tubular element 2. After the circular rib 8 has gone past, the connection catches 11 move radially towards each other and are held tight against the male endpiece of the second tubular element 3, behind the circular rib 8. The connection catches 11 then co-operate with the circular rib 8 to block the second tubular element 3 axially relative to the first tubular element 2, via the latch 6.

In known manner, by pressing on the bars 9, the latch 6 deforms so that the connection catches 11 move apart, thereby releasing the circular rib 8 of the second tubular element 3, which can then be withdrawn axially from the body 4 of the first tubular element 2.

In the example embodiment of the invention, the ring 7, shown in FIGS. 4A and 4B, presents a perimeter that can be divided into two portions, which two portions may match symmetrically. A first perimeter portion of the ring 7 is for arranging in the body 4 of the first tubular element 2, and a second perimeter portion is for leaving projecting outside the body 4.

The perimeter portion of the ring 7 that is to be inserted inside the first tubular element 2 is flexible, and in this example has a rib forming a retaining catch 12 that extends radially outwards from the ring 7. In this example, the ring 7 has two retaining catches 12 that are diametrically opposite. The retaining catches 12 co-operate with a groove 13 located in the inside face of the hollow body 4, corresponding to one of the edges of the lateral openings 10 present in the body 4, in order to block the ring 7 axially in the hollow body 4.

The perimeter portion of the ring 7 that is to be inserted inside the first tubular element 2 has a sloping section that extends radially towards the inside of the ring, forming a rib 14. The end of the rib 14 is in the form of a barb catch 15 facing towards the outside of the ring 7. In this example, the ring 7 has two ribs 14 that are diametrically opposite.

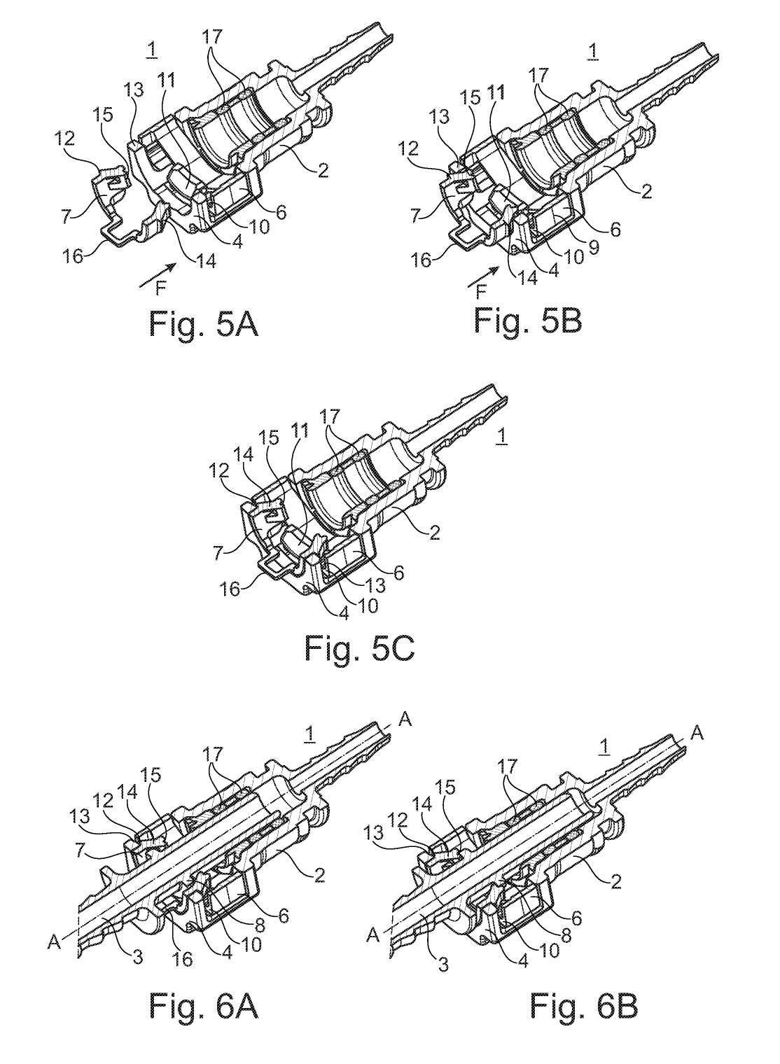

FIGS. 5A to 5C show the ring 7 being inserted axially in the hollow body 4 along arrow F.

The ribs 14 of the ring 7 are arranged so that during axial engagement of the ring 7 in the axial orifice 5 along the arrow F of FIGS. 5A and 5B, the pressure of the sloping ribs 14 against the walls of the orifice 5 cause the ring 7 to be tightened radially, thus allowing the ring 7 to pass through the orifice 5. After the ribs 14 have passed through the ring 7 expands radially so that the retaining catches 12 are received in the groove 14 in the body 4, as shown in FIG. 5C.

The ribs 14 of the ring 7 are also arranged so that during axial engagement of the second tubular element 3 in the axial orifice 5 as shown in FIGS. 6A and 6B, the circular rib 8 pressing axially against the ribs 14 of the ring 7 causes the ribs 14 of the ring 7 to move radially apart, thus enabling the circular rib 8 to pass between the ribs 14 of the ring 7 and enabling the second tubular element 3 to be inserted in the first tubular element 2. After going past the circular rib 8, the ribs 14 of the ring 7 move radially towards each other and press tight against the endpiece of the second tubular element 3 behind the circular rib 8. The barb catches 15 of the ribs 14 of the ring 7 then co-operate with the circular rib 8 to block the second tubular element 3 axially relative to the first tubular element 2, via the latch 6.

The ribs 14 of the ring 7 and the connection catches 11 of the latch can be arranged to move apart and move towards each other simultaneously relative to the circular rib 8 of the second tubular element 3.

The perimeter portion of the ring 7 that is to remain outside the body 4 of the first tubular element 2 is in the form of a loop 16. The loop 16 is arranged so as to project to the outside of the body 4 of the first tubular element 2 when the ring 7 is in a preassembly position in the body 4 of the first tubular element 2 (FIGS. 1 and 5C) and so as to remain accessible to a tool when the second tubular element 3 is connected to the tubular coupling 1. A particular feature of the loop 16 is that it can be broken by means of the tool.

In the example embodiment of the invention, the perimeter portion of the ring 7 that is to remain outside the body 4 of the first tubular element 2 may also present some other shape, for example a semicircle, an omega shape, or a triangle.

In the above-described embodiment, when the first and second tubular elements 2 and 3 are connected together, the connection catches 11 of the latch 6 and the ribs 14 of the ring oppose withdrawal of the second tubular element 3. By pressing on the press bars 9 of the latch 6, the connection catches 11 of the latch 6 release the second tubular element 3, but it remains in place in the first tubular element 2 since the ribs 14 of the ring 7 continue to oppose withdrawal of the second tubular element 3, thereby providing security for the first connection.

Nevertheless, in accordance with the example embodiment of the invention, it is possible to extract the second tubular element 3 from the first tubular element 2. In order to withdraw the second tubular element 3 from the first tubular element 2, it is necessary to break the ring 7 using a tool acting on the breakable loops 16 accessible from the outside of the body 4 of the coupling 1. Once the ring 7 has been broken, these ribs 14 of the ring 7 are no longer axially retained in the body 4 so action on the bars 9 of the latch 6 enables the second tubular element 3 to be disconnected from the first tubular element 2.

In accordance with the example embodiment of the invention, a new ring 7 can be inserted in the body 4 of the coupling so that the tubular coupling 1 can be used once more with a high level of security.

In order to guarantee fluid sealing between the first and second tubular elements 2 and 3 when they are connected together, gaskets 17 are arranged in the hollow body 4 of the first tubular element 2.

Another advantage of the tubular coupling 1 of the example embodiment of the invention is to improve the mechanical retention of the second tubular element 3 in the tubular coupling 1 without degrading the force needed for connection. Specifically, the circular rib 8 of the second tubular element 3 is held axially at four points instead of at two as in conventional couplings. Furthermore, the barb shapes present on the ring 7 can accept some minimum level of force to deform them while inserting the second tubular element 3 in the first tubular element 2.

The various elements of the tubular coupling 1 of the example embodiment of the invention, i.e. the first tubular element 2, the latch 6, and the ring 7, may be made entirely by molding plastics material. Such a tubular coupling 1 can be fabricated at low cost.

These elements could equally well be fabricated by adding material in a 3D printer, e.g. if only short runs are to be fabricated.

Tubular couplings of the example embodiment of the invention can be used for coupling together two fluid transport pipes in the field of the automobile industry, and are entirely suitable for use in washroom applications in order to avoid couplings being disassembled in involuntary manner or without a tool.

1. A tubular quick coupling comprising a first tubular element with a hollow connector body defining an axial orifice that is to receive a second tubular element provided with a circular rib, a latch blocked axially in said first tubular element and radially actuatable to release said second tubular element from said first tubular element, and a security system that prevents said second tubular element being withdrawn, wherein said security system is a flexible and breakable ring that has a perimeter portion inside said first tubular element between the inlet of said orifice of said body and said latch in order to block said second tubular element coaxially in said first tubular element in spite of actuating said latch, said ring having at least one perimeter portion in the form of a breakable loop that projects outside said body.

2. A coupling according to claim 1, wherein said ring includes on said perimeter portion inside said first tubular element at least one rib that slopes radially so that during axial engagement of said second tubular element in said axial orifice, the rib moves radially outwards under the effect of the axial pressure of said circular rib on said sloping rib so as to allow said circular rib to pass through and then be held tight behind said circular rib.

3. A coupling according to claim 2, wherein said sloping rib further includes a barb catch that comes into contact with said circular rib of said second tubular element and an inside groove of said hollow body to block said second tubular element axially in said first tubular element.

4. A coupling according to claim 1, wherein said ring has two sloping ribs that are diametrically opposite.

5. A coupling according to claim 1, wherein said ring includes at least one retaining catch that co-operates with an internal groove of said hollow body to block said ring axially in said body of said first tubular element.

6. A coupling according to claim 1, wherein said ring has two opposite loops.
